(19) United States
(12) Patent Application Publication
(10) Pub. No.: US 2024/0334879 A1
(43) Pub. Date: Oct. 10, 2024

(54) WASTE-REDUCING BALE WRAP ASSEMBLY FOR AN AGRICULTURAL BALER

(71) Applicant: CNH Industrial Canada, Ltd., Saskatoon (CA)

(72) Inventor: Martin J. Roberge, Quebec (CA)

(21) Appl. No.: 18/629,396

(22) Filed: Apr. 8, 2024

Related U.S. Application Data
(60) Provisional application No. 63/457,831, filed on Apr. 7, 2023.

(51) Int. Cl. A01F 15/07

(52) U.S. Cl. CPC A01F 15/071; A01F 2015/0745

(57) ABSTRACT

A bale wrap assembly for an agricultural baler includes a segmented shaft having multiple segments configured to couple to one another along a rotational axis of the segmented shaft. The bale wrap assembly also includes a bale wrap configured to be disposed about the segmented shaft. Furthermore, the bale wrap assembly includes at least one engagement feature positioned at an end of the bale wrap and configured to engage the segmented shaft. The at least one engagement feature is configured to couple the segments to one another while engaged with the segmented shaft, and the at least one engagement feature is configured to disengage the segmented shaft as the end of the bale wrap moves away from the segmented shaft to enable the segments to uncouple from one another.

### BACKGROUND

The present disclosure relates generally to a waste-reducing bale wrap assembly for an agricultural baler.

Agricultural balers are used to compress an agricultural product (e.g., cotton or other natural material(s)) into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale. The bale wrap may be formed from a natural material, such as cotton or hemp. As a result, the bale wrap may biodegrade after use or be shredded during bale processing, thereby reducing waste.

### BRIEF DESCRIPTION

In certain embodiments, a bale wrap assembly for an agricultural baler includes a segmented shaft having multiple segments configured to couple to one another along a rotational axis of the segmented shaft. The bale wrap assembly also includes a bale wrap configured to be disposed about the segmented shaft. Furthermore, the bale wrap assembly includes at least one engagement feature positioned at an end of the bale wrap and configured to engage the segmented shaft. The at least one engagement feature is configured to couple the segments to one another while engaged with the segmented shaft, and the at least one engagement feature is configured to disengage the segmented shaft as the end of the bale wrap moves away from the segmented shaft to enable the segments to uncouple from one another.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having a bale wrapping system;

FIG. 2 is a schematic diagram of an embodiment of a bale wrapping system that may be employed within the agricultural system of FIG. 1;

FIG. 3 is a schematic diagram of an embodiment of a bale wrap assembly that may be employed within the agricultural system of FIG. 1;

FIG. 4 is a schematic diagram of a portion of the bale wrap assembly of FIG. 3, in which a bale wrap of the bale wrap assembly is separated from a segmented shaft of the bale wrap assembly, and segments of the segmented shaft are uncoupled from one another;

FIG. 5 is a cross-sectional view of a portion of another embodiment of a bale wrap assembly that may be employed within the agricultural system of FIG. 1;

FIG. 6 is a cross-sectional view of a portion of a further embodiment of a bale wrap assembly that may be employed within the agricultural system of FIG. 1;

FIG. 7 is a top view of a portion of an embodiment of a bale wrap assembly that may be employed within the agricultural system of FIG. 1;

FIG. 8 is a top view of a portion of another embodiment of a bale wrap assembly that may be employed within the agricultural system of FIG. 1; and

FIG. 9 is a cross-sectional view of a portion of a further embodiment of a bale wrap assembly that may be employed within the agricultural system of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

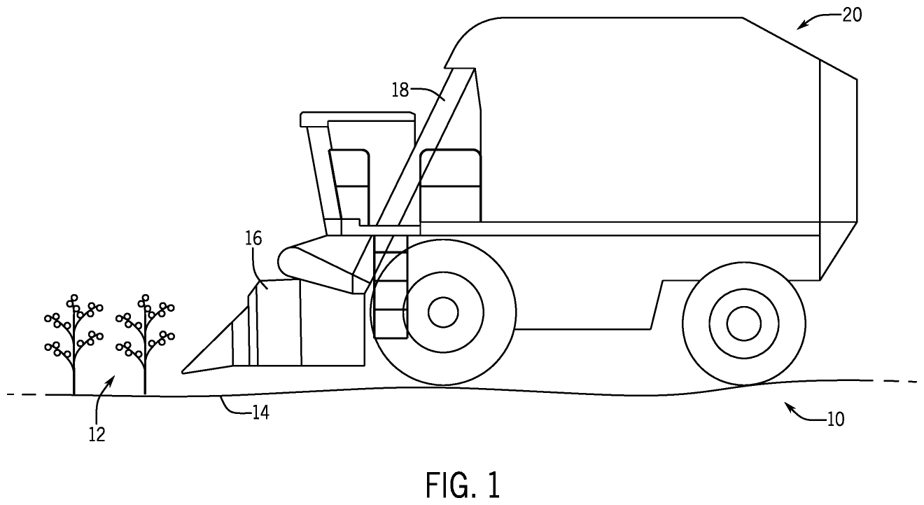

FIG. 1 is a side view of an embodiment of an agricultural system 10 (e.g., harvester) having a bale wrapping system. The agricultural system 10 is configured to harvest agricultural product 12 (e.g., cotton) from a field 14 and to form the agricultural product 12 into bales (e.g., agricultural bales). For example, the agricultural system 10 includes a header 16 having drums configured to harvest the agricultural product 12 from the field 14. Additionally, the agricultural system 10 includes an air-assisted conveying system 18 configured to move the agricultural product 12 from the drums of the header 16 to a baler 20 (e.g., agricultural baler). The baler 20 is supported by and/or mounted within or on a chassis of the agricultural system 10. As discussed in detail below, the baler 20 may form the agricultural product 12 into round bales. However, in other embodiments, the baler 20 of the agricultural system 10 may form the agricultural product into square bales, polygonal bales, or bales of other suitable shape(s). As described in greater detail below, after forming the agricultural product 12 into a bale, the bale wrapping system of the agricultural system 10 wraps the bale with a bale wrap to secure the agricultural product 12 within the bale and to generally maintain a shape of the bale.

As discussed in detail below, the baler 20 includes a bale wrap assembly configured to provide the bale wrapping system with the bale wrap. In certain embodiments, the bale wrap assembly includes a segmented shaft having multiple segments configured to couple to one another along a rotational axis of the segmented shaft. The bale wrap assembly also includes the bale wrap, which is configured to be disposed about the segmented shaft. Furthermore, the bale wrap assembly includes engagement feature(s) positioned at an end of the bale wrap and configured to engage the segmented shaft. The engagement feature(s) are configured to couple the segments of the segmented shaft to one another while engaged with the segmented shaft. In addition, the engagement feature(s) are configured to disengage the segmented shaft as the end of the bale wrap moves away from the segmented shaft to enable the segments of the segmented shaft to uncouple from one another. Accordingly, as the bale wrap is provided to the bale wrapping system, the engagement feature(s) couple the segments of the segmented shaft to one another, thereby enabling the segmented shaft to support the bale wrap disposed about the segmented shaft. However, as the end of the bale wrap moves away from the segmented shaft (e.g., as the last portion of the bale wrap is being used by the bale wrapping system), the engagement feature(s) disengage the segmented shaft, thereby enabling the segments of the segmented shaft to uncouple from one another. As a result, the segmented shaft may break into the individual segments and move (e.g., under the influence of gravity) to a storage compartment or through an outlet of the baler to the field. For example, in certain embodiments, the segmented shaft is formed entirely from biodegradable material. Accordingly, depositing the segments of the segmented shaft on the field enables the segmented shaft to biodegrade, thereby reducing waste.

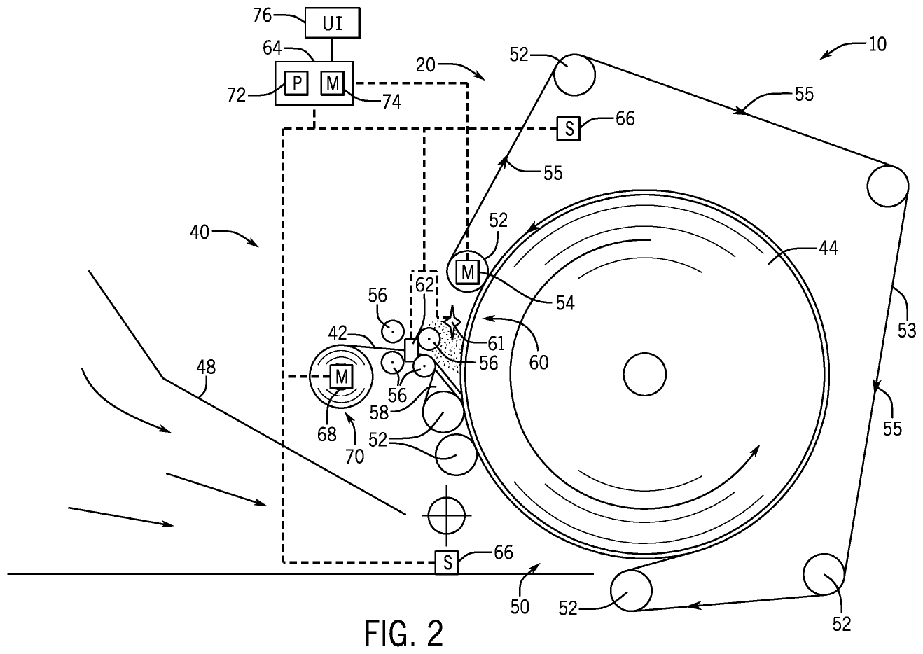

FIG. 2 is a schematic diagram of an embodiment of a bale wrapping system 40 that may be employed within the agricultural system 10 of FIG. 1. A bale wrap 42 is configured to wrap around a bale 44 (e.g., a bale of the agricultural product, an agricultural bale, etc.) formed by the baler 20 of the agricultural system 10. As cotton or another agricultural product is harvested, the agricultural product flows into an accumulator 48 (e.g., bale chamber) and/or a feeding system. For example, cotton may be blown by the air-assisted conveying system into the accumulator/bale chamber 48. The cotton is then fed into a cavity 50 of the baler 20. The baler 20 includes multiple rollers 52 that support and/or drive rotation of one or more belts 53. For example, one or more rollers 52 engage the belt(s) 53, which enable the belt(s) 53 to move along the pathway defined by the rollers 52 and the bale 44. One or more rollers are driven to rotate via a belt drive system 54 (e.g., including electric motor(s), hydraulic motor(s), pneumatic motor(s), etc.). The belt(s) 53 circulate around the path defined by the rollers 52 and the bale 44, as indicated by arrows 55. Movement of the belt(s) 53 captures agricultural product from the accumulator 48 and draws the agricultural product into the cavity 50, where the agricultural product is gradually built up to form the bale 44. As the agricultural product builds within the cavity 50, one or more of the rollers 52 may move radially outward to accommodate the increasing size of the bale 44.

Once the bale 44 reaches a desired size, the bale wrapping system 40 wraps the bale 44 with the bale wrap 42. The bale wrap 42 may include cotton, hemp, flax, other suitable material(s) (e.g., biodegradable material(s), natural material(s)), or a combination thereof. In certain embodiments, the bale wrap 42 may include only cotton. Additionally, the bale wrap 42 may include canvas, fabric, cloth, other suitable material(s), or a combination thereof.

The bale wrap 42 is fed into contact with the bale 44 with one or more feed rollers 56 and over a wrap guide or wrap applicator 58 (e.g., duckbill). The wrap guide/wrap applicator 58 is configured to move (e.g., rotate) to direct the bale wrap 42 into contact with the bale 44. The bale wrap 42 is captured between the bale 44 and the belt(s) 53. Accordingly, rotation of the bale 44 draws the bale wrap 42 around the bale 44, thereby wrapping the bale 44.

To secure the bale wrap 42 around the bale 44, the bale wrapping system 40 includes an adhesive system 60. The adhesive system 60 includes one or more sprayers 61 that spray an adhesive onto the bale wrap 42 (e.g., one side of the bale wrap 42). Additionally or alternatively, the sprayer(s) may spray an activator (e.g., water) onto the bale wrap 42 to activate an adhesive (e.g., water-soluble film, powder embedded within the bale wrap, etc.). Accordingly, the adhesive system 60 may create an adhesive layer on the bale wrap 42, thereby coupling the bale wrap 42 to itself, which secures the bale wrap 42 around the bale 44. For example, a first portion of the bale wrap 42 couples (e.g., adheres) to a second portion (e.g., a backside and/or an exterior surface) of the bale wrap 42 with the adhesive provided by and/or activated by the adhesive system 60 as the first portion overlaps the second portion. The bale wrap 42 is then cut with a cutter or cutting system 62 to separate additional bale wrap 42 (e.g., on a shaft of a bale wrap assembly) from the bale wrap 42 surrounding the bale 44.

The cutting system 62 is configured to cut the bale wrap 42 to a suitable length for wrapping the bale 44. For example, the length of the bale wrap 42 may be selected based on a size of the bale 44 and a desired number of wraps of the bale wrap 42 (e.g., the number of times the bale wrap 42 wraps around a circumferential side of the bale 44). The cutting system 62 may include a cutting mechanism, an actuation assembly coupled to the cutting mechanism, and a track. The cutting mechanism may include a knife that engages the bale wrap 42 to cut the bale wrap 42. In other embodiments, the cutting mechanism may include other suitable mechanism(s) configured to cut the bale wrap (e.g., a rotary knife, a duckbill knife, a saw, a shear bar, etc.). In some embodiments, the actuation assembly is configured to move the cutting mechanism along a track to selectively drive the cutting mechanism into engagement with the bale wrap 42. In certain embodiments, the bale wrap 42 may have partially pre-cut sections (e.g., perforated sections) to facilitate cutting the bale wrap 42 by the cutting system 62.

The bale wrap 42 is configured to wrap around the bale 44 to secure the agricultural product within the bale 44 and to generally maintain a shape of the bale 44, such as the round shape in the illustrated embodiment. In other embodiments, the shape of the bale may be rectangular, polygonal, or another suitable shape. The bale wrapping system 40 may wrap the bale 44 with the bale wrap 42 once or multiple times. For example, the bale wrap 42 may form one wrap (e.g., layer), one wrap and a portion of another wrap, two wraps, or five wraps around the bale 44. The adhesive system 60 may spray various circumferential lengths of adhesive/activator along the bale wrap 42. For example, the adhesive system 60 may spray along a circumferential portion of the bale wrap 42 that extends less than 25 percent, 50 percent, 75 percent, or 100 percent of the circumferential extent of the bale 44. The sprayed portion of the bale wrap 42 may also cover more than one wrap of the bale wrap 42. In some embodiments, the portion of the bale wrap 42 sprayed with the adhesive/activator may be a selected length (e.g., 1 cm, 15 cm, 30 cm, 60 cm, 90 cm, 120 cm, 150 cm, or more).

In certain embodiments, the agricultural system 10 includes a controller 64. The controller 64 may be configured to control rotation of the belt(s) 53 and/or a belt speed of the belt(s) 53. For example, in the illustrated embodiment, the controller 64 is communicatively coupled to the belt drive system 54, and the controller 64 is configured to control a rotation rate of one or more rollers 52 to control the belt speed of the belt(s) 53. The controller 64 may control the belt speed of the belt(s) 53 in response to feedback from one or more sensors 66. The sensor(s) 66 are communicatively coupled to the controller 64, and the sensor(s) 66 are configured to output sensor signal(s) indicative of a flow rate of agricultural material, size of the bale 44, other suitable parameter(s), or a combination thereof.

In addition, the sensor(s) 66 may enable the controller 64 to determine when to apply adhesive/activator to the bale wrap 42. In some embodiments, upon determining the bale 44 has reached a desired size (e.g., based on feedback from the sensor(s) 66), the controller 64 may automatically activate a bale wrapping process. For example, the controller 64 may receive signal(s) from the sensor(s) 66 indicative of the size of the bale 44 (e.g., weight, diameter, circumference, etc.). Upon determining the bale 44 has reached a target size, the controller 64 may activate the bale wrapping system 40 to initiate the bale wrapping process. For example, in the illustrated embodiment, the controller 64 is communicatively coupled to a bale wrap shaft drive system 68 (e.g., including electric motor(s), hydraulic motor(s), pneumatic motor(s), etc.), which is coupled to a shaft of a bale wrap assembly 70 and configured to drive the shaft to rotate. The bale wrap assembly 70 includes the shaft and the bale wrap 42 disposed about the shaft. The controller 64 may activate the bale wrap shaft drive system 68 to begin feeding the bale wrap 42 toward the bale 44. In some embodiments, the wrap guide 58 (e.g., duckbill) may be actuated (e.g., rotated), which drives the bale wrap 42 into contact with the bale 44. As previously discussed, the bale wrap 42 is captured between the bale 44 and the belt(s) 53. Accordingly, rotation of the belt(s) 53 draws the bale wrap 42 around the bale 44.

The controller 64 may then determine the extent (e.g., length) of the bale wrap 42 around the bale 44 based on feedback from the sensor(s) 66. Once a target amount of wrapping is complete, the controller 64, which is communicatively coupled to the adhesive system 60, may activate the adhesive system 60. The controller 64 may then control the amount of adhesive/activator sprayed onto the bale wrap 42 and/or how much of the bale wrap 42 is sprayed with adhesive/activator (e.g., circumferential extent of the bale wrap 42 that is sprayed with adhesive/activator). In some embodiments, depending on the size of the bale 44, the controller 64 may control the adhesive system 60 to spray more or less adhesive/activator onto the bale wrap 42 and/or control how much of the bale wrap 42 is sprayed with adhesive/activator. For example, if the bale 44 is small, less adhesive/activator may be used and/or less bale wrap 42 may be sprayed with adhesive/activator. However, if the bale 44 is large, more adhesive/activator may be sprayed onto the bale wrap 42 and/or more of the bale wrap 42 may be sprayed with adhesive/activator.

The controller 64 is configured to control movement and operation of the cutting system 62 as well. For example, the controller 64, which is communicatively coupled to the cutting system 62, may control engagement of a cutting mechanism of the cutting system 62 with the bale wrap 42, such that the cutting mechanism cuts the bale wrap 42. As illustrated, the cutting system 62 is positioned upstream of the sprayer(s) 61 of the adhesive system 60 relative to the direction of movement of the bale wrap 42. Once the bale wrap 42 is cut and the bale wrap shaft drive system 68 terminates rotation of the shaft of the bale wrap assembly 70, the bale wrap 42 continues to rotate with the bale 44, thereby enabling a portion of the bale wrap 42 with adhesive/activated adhesive to contact and adhere to another portion of the bale wrap 42 that is disposed about the bale 44.

In certain embodiments, the controller 64 may control the adhesive system 60, the cutting system 62, the bale wrap shaft drive system 68, and the belt drive system 54 to control the bale wrapping process. For example, in response to the controller 64 determining that the bale 44 is in condition for wrapping, the controller 64 may control the belt drive system 54 to control the belt speed of the belt(s) 53, such that the belt(s) 53 reach a target belt speed for wrapping the bale 44. The target belt speed for wrapping the bale may be greater than or less than a target belt speed for bale formation. In certain embodiments, the belt speed may not be adjusted for wrapping the bale 44 (e.g., the target belt speed for wrapping the bale may be equal to the target belt speed for bale formation). The controller 64 may determine that the bale 44 is in condition for wrapping based on a weight of the bale 44 (e.g., based on feedback from the sensor(s) 66), a duration of the bale forming process, instructions from another controller (e.g., a harvester controller) to wrap the bale 44, based on a size of the bale 44 (e.g., based on feedback from the sensor(s) 66), other suitable parameter(s), or a combination thereof. In response to determining the bale is in condition for wrapping, the controller 64 may control the bale wrap shaft drive system 68 to feed the bale wrap 42 toward the bale 44. The controller 64 may then output a signal to actuate the adhesive system 60. Concurrently or a selected duration thereafter, the controller 64 may output a signal to the cutting system 62 to drive the cutting mechanism into engagement with the bale wrap 42, thereby cutting the bale wrap 42. Thereafter, the controller 64 may control the belt drive system 54 to stop rotation of the belt(s) 53. The wrapped bale 44 may then be ejected from the agricultural system 10.

In the illustrated embodiment, the controller 64 of the bale wrapping system 40 includes a processor 72 and a memory 74. The processor 72 (e.g., a microprocessor) may be used to execute software, such as software stored in the memory 74 for controlling the bale wrapping system 40 (e.g., for controlling rotation of the bale 44, the adhesive system 60, the cutting system 62, etc.). Moreover, the processor 72 may include multiple microprocessors, one or more “general-purpose” microprocessors, one or more special-purpose microprocessors, and/or one or more application specific integrated circuits (ASICS), or some combination thereof. For example, the processor 72 may include one or more reduced instruction set (RISC) or complex instruction set (CISC) processors.

The memory 74 may include a volatile memory, such as random-access memory (RAM), and/or a nonvolatile memory, such as read-only memory (ROM). The memory 74 may store a variety of information and may be used for various purposes. For example, the memory 74 may store processor-executable instructions (e.g., firmware or software) for the processor 72 to execute, such as instructions for controlling the bale wrapping system 40. In certain embodiments, the controller 64 may also include one or more storage devices and/or other suitable components. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the bale wrapping system 40), and any other suitable data. The processor 72 and/or the memory 74, and/or an additional processor and/or memory device, may be located in any suitable portion of the agricultural system 10.

Additionally, the bale wrapping system 40 includes a user interface 76 communicatively coupled to the controller 64. The user interface 76 may be configured to provide information to an operator (e.g., indicative of the rotation rate of the bale 44, the belt speed of the belt(s) 53, an amount of the bale wrap 42 remaining on the shaft of the bale wrap assembly 70, a size of the bale 44, an amount of adhesive/activator remaining, other suitable parameter(s), or a combination thereof). Additionally, the user interface 76 may be configured to enable operator interactions with the bale wrapping system 40, such as control of the adhesive system 60, control of the cutting system 62, control of the belt(s) 53, control of other parameter(s), or a combination thereof. For example, the user interface 76 may include a display and/or other user interaction device(s) (e.g., button(s)) configured to enable operator interactions.

As previously discussed, the bale wrap assembly 70 includes a shaft and the bale wrap 42, which is configured to be disposed about the shaft. In certain embodiments, the shaft is segmented and includes multiple segments configured to couple to one another along a rotational axis of the segmented shaft. Furthermore, the bale wrap assembly 70 includes engagement feature(s) positioned at an end of the bale wrap 42 and configured to engage the segmented shaft. The engagement feature(s) are configured to couple the segments of the segmented shaft to one another while engaged with the segmented shaft. In addition, the engagement feature(s) are configured to disengage the segmented shaft as the end of the bale wrap 42 moves away from the segmented shaft to enable the segments of the segmented shaft to uncouple from one another. Accordingly, as the bale wrap 42 is provided to the bale wrapping system 40, the engagement feature(s) couple the segments of the segmented shaft to one another, thereby enabling the segmented shaft to support the bale wrap 42 disposed about the segmented shaft. However, as the end of the bale wrap 42 moves away from the segmented shaft (e.g., as the last portion of the bale wrap 42 is being used by the bale wrapping system 40), the engagement feature(s) disengage the segmented shaft, thereby enabling the segments of the segmented shaft to uncouple from one another. As a result, the segmented shaft may break into the individual segments and move (e.g., under the influence of gravity) to a storage compartment or through an outlet of the baler to the field. For example, in certain embodiments, the segmented shaft is formed entirely from biodegradable material. Accordingly, depositing the segments of the segmented shaft on the field enables the segmented shaft to biodegrade, thereby reducing waste.

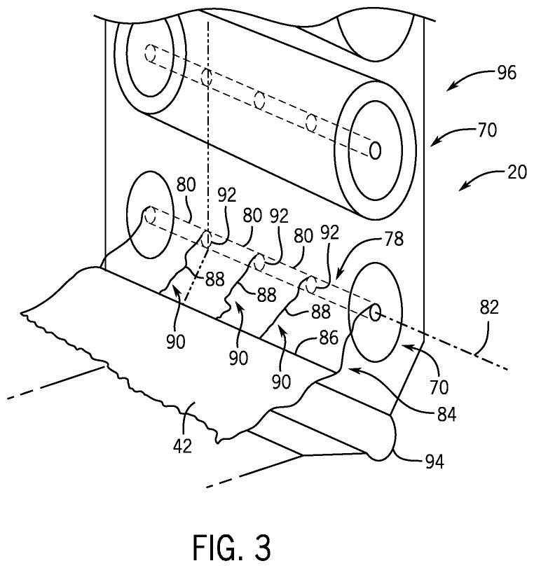

FIG. 3 is a schematic diagram of an embodiment of a bale wrap assembly 70 that may be employed within the agricultural system of FIG. 1. In the illustrated embodiment, the bale wrap assembly 70 includes a segmented shaft 78 having multiple segments 80 configured to couple to one another along a rotational axis 82 of the segmented shaft 78. Furthermore, the bale wrap assembly 70 includes the bale wrap 42, which is configured to be disposed about the segmented shaft 78 (e.g., before and during the bale wrapping process). As previously discussed, during the bale wrapping process, the bale wrap shaft drive system, which is coupled to the segmented shaft 78, drives the segmented shaft 78 to rotate about the rotational axis 82, thereby feeding the bale wrap 42 toward the bale.

Furthermore, in the illustrated embodiment, the bale wrap assembly 70 includes one or more engagement features 84 positioned at an end 86 of the bale wrap 42 (e.g., trailing end of the bale wrap). The engagement feature(s) 84 are configured to engage the segmented shaft 78 and to couple the segments 80 of the segmented shaft 78 to one another while engaged with the segmented shaft 78. In addition, the engagement feature(s) 84 are configured to disengage the segmented shaft 78 as the end 86 of the bale wrap 42 moves away from the segmented shaft 78 to enable the segments 80 to uncouple from one another. With the segments 80 uncoupled from one another, the segments 80 may move (e.g., under the influence of gravity) to a storage compartment or through an outlet of the baler to the field.

In the illustrated embodiment, each engagement feature 84 includes a strip of material 88 coupled to the bale wrap 42 and configured to be disposed about the segmented shaft 78. In addition, each engagement feature 84 includes an adhesive 90 configured to couple a respective strip of material 88 to the segmented shaft 78 at a respective interface 92 between two segments 80. Accordingly, while the bale wrap 42 is disposed about the segmented shaft 78, the strips of material 88 are wrapped around the segmented shaft 78 at the respective interfaces 92. In addition, the adhesive 90 couples each strip of material 88 to the segmented shaft 78 at the respective interface 92. As a result, the engagement features 84 couple the segments 80 to one another, thereby forming the segmented shaft 78, which has sufficient structural integrity to support the bale wrap 42. As the end 86 of the bale wrap 42 moves away from the segmented shaft 78, the strips of material 88, which are coupled to the bale wrap 42, disengage the segmented shaft 78 (e.g., unroll from the segmented shaft 78), thereby enabling the segments 80 to uncouple from one another. Each strip of material 88 may be formed from any suitable material(s), such as a natural material (e.g., cotton, flax, hemp, etc.). For example, in certain embodiments, each strip of material 88 may be formed from the same material(s) as the bale wrap 42. While each engagement feature 84 includes a strip of material 88 and adhesive 90 in the illustrated embodiment, in other embodiments, at least one engagement feature may include other suitable element(s).

In the illustrated embodiment, the segmented shaft 78 includes four segments 80, which are coupled to one another by three engagement features 84. However, in other embodiments, the segmented shaft may include more or fewer segments (e.g., 2, 3, 5, 6, 7, 8, 9, 10, or more), and the bale wrap assembly may include a corresponding number of engagement features (e.g., one less than the number of segments). Furthermore, in certain embodiments, each segment may abut an adjacent segment, and the segments may be coupled to one another by the engagement features. In certain embodiments, the segmented shaft may include an adhesive configured to couple adjacent segments to one another. Additionally or alternatively, at least one segment may include a protrusion extending along the rotational axis and configured to engage a corresponding recess in an adjacent segment, thereby facilitating coupling of the segments to one another.

In the illustrated embodiment, the baler 20 includes a ramp 94 positioned below the segmented shaft 78. The ramp 94 is configured to receive the segments 80 of the segmented shaft 78 in response to the segments 80 being uncoupled from one another. In addition, the ramp 94 is configured to direct the segments 80 toward the field. For example, the ramp 94 may be sloped downwardly toward an exit of the baler 20. Accordingly, as the segmented shaft 78 breaks into individual segments 80 (e.g., in response to the engagement feature(s) 84 disengaging the segmented shaft 78), the segments 80 may move (e.g., under the influence of gravity) to the ramp 94. In addition, the ramp 94 may direct the segments 80 (e.g., enable the segments 80 to move under the influence of gravity) through the outlet of the baler 20 and toward the field. As discussed in detail below, the segmented shaft 78 may be formed entirely from biodegradable material, thereby enabling the segments 80 to biodegrade on the field. While the baler 20 includes the ramp 94 in the illustrated embodiment, in other embodiments, the ramp may be omitted. For example, the segments may fall directly unto the field, or the segments may fall into a storage compartment.

In the illustrated embodiment, the baler 20 includes a hopper system 96 configured to automatically move a subsequent bale wrap assembly 70 into an unloading position in response to the segments 80 of the segmented shaft 78 of the previous bale wrap assembly 70 uncoupling from one another. For example, as the segments 80 of the previous bale wrap assembly 70 move downwardly (e.g., under the influence of gravity), the subsequent bale wrap assembly 70 may automatically move to the unloading position, thereby enabling the bale wrap of the subsequent bale wrap assembly 70 to be fed into the bale wrapping system for subsequent bale wrapping operations. The hopper system 96 may include a mechanical system configured to automatically move the subsequent bale wrap assembly 70 into the loading position. For example, uncoupling of the segments of the segmented shaft of the previous bale wrap assembly may release a mechanical switch that enables the subsequent bale wrap assembly to move to the unloading position (e.g., under the influence of gravity). Alternatively, the hopper system 96 may include an electronic system configured to determine that the segments of the segmented shaft of the previous bale wrap assembly have uncoupled from one another (e.g., based on sensor feedback) and control one or more actuators to move the subsequent bale wrap assembly into the unloading position. While the baler 20 includes the hopper system 96 in the illustrated embodiment, in other embodiments, the hopper system may be omitted.

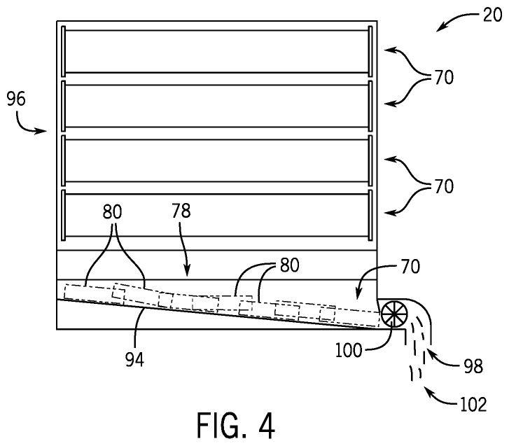

FIG. 4 is a schematic diagram of a portion of the bale wrap assembly 70 of FIG. 3, in which the bale wrap of the bale wrap assembly 70 is separated from the segmented shaft 78 of the bale wrap assembly 70, and the segments 80 of the segmented shaft 78 are uncoupled from one another. As illustrated, the segments 80 of the segmented shaft 78 are positioned on the ramp 94. As previously discussed, the ramp 94 is configured to direct the segments 80 toward the field. In the illustrated embodiment, the ramp 94 is sloped downwardly toward an exit 98 of the baler 20. Accordingly, the ramp 94 may direct the segments 80 (e.g., enable the segments 80 to move under the influence of gravity) through the outlet 98 of the baler 20 and toward the field.

In the illustrated embodiment, the baler 20 includes a shredder 100 configured to receive the segments 80 of the segmented shaft 78 in response to the segments 80 being uncoupled from one another. For example, the ramp 94 may direct the segments 80 (e.g., enable the segments 80 to move under the influence of gravity) toward the shredder 100. In addition, the shredder 100 is configured to shred each segment 80 to form segment material 102. The shredder 100 is also configured to direct the segment material 102 to the field. In certain embodiments, the shredder 100 includes a blade assembly (e.g., including a radial array of blades) and a motor (e.g., electric motor, hydraulic motor, pneumatic motor, etc.) configured to drive the blade assembly to rotate. In such embodiments, rotation of the blade assembly may shred the segments as the segments engage the blade assembly. While the shredder having a rotating blade assembly is disclosed above, in certain embodiments, the shredder may include a translating blade assembly (e.g., chopper, etc.) or other suitable type of shredding device. While the baler 20 includes the shredder 100 in the illustrated embodiment, in other embodiments, the shredder may be omitted. In such embodiments, the intact segments may be disposed onto the field.

In certain embodiments, the segmented shaft 78 is formed entirely from biodegradable material. Accordingly, depositing the segments 80 (e.g., after shredding) onto the field may enable the segments 80 to biodegrade, thereby reducing waste. The segmented shaft 78 may be formed from a substantially rigid biodegradable material that enables the segmented shaft to support the bale wrap during the bale wrapping process. For example, the segmented shaft 78 may be formed from Miscanthus/Switchgrass, hemp, or cardboard formed with organic glue. While depositing the segments 80 onto the field is disclosed above, in certain embodiments, the segments 80 may be stored within a storage compartment of the baler. In such embodiments, the segmented shaft may be formed from biodegradable material and/or other suitable material(s).

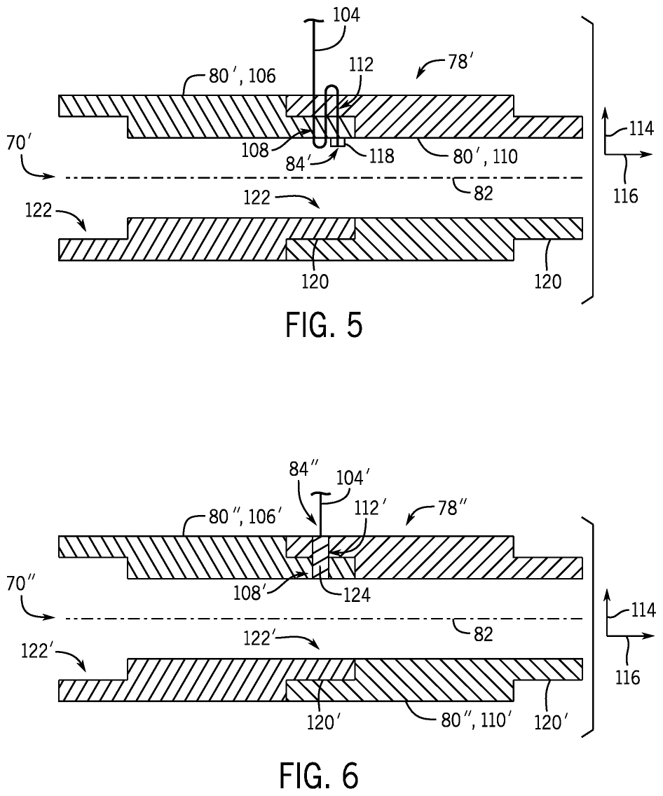

FIG. 5 is a cross-sectional view of a portion of another embodiment of a bale wrap assembly 70′ that may be employed within the agricultural system of FIG. 1. In the illustrated embodiment, at least one engagement feature 84′ (e.g., each engagement feature of the bale wrap assembly) includes a string 104. The string 104 is positioned at the end of the bale wrap (e.g., extending from the end of the bale wrap). For example, the string 104 may be coupled to the bale wrap via a sewed connection, an adhesive connection, a fastener connection, other suitable type(s) of connection(s), or a combination thereof.

As illustrated, the string 104 extends through apertures of each segment 80′. In the illustrated embodiment, a first segment 106 has three apertures 108, and a second segment 110 has three apertures 112. Furthermore, in the illustrated embodiment, each aperture extends through the respective segment 80′ along a radial axis 114, and each aperture 108 of the first segment 106 is substantially aligned with a respective aperture 112 of the second segment 110 with respect to a longitudinal axis 116 (e.g., which is parallel to the rotational axis 82). The string 104 extends through each aperture 108 of the first segment 106 and through each aperture 112 of the second segment 110, thereby coupling the first segment 106 and the second segment 110 to one another. As illustrated, the string 104 extends through each pair of longitudinally aligned apertures in opposite directions, thereby establishing a sewed connection that couples the first segment 106 and the second segment 110 to one another.

In the illustrated embodiment, the engagement feature 84′ includes an end cap 118 coupled to the end of the string 104 (e.g., the end opposite the end coupled to the bale wrap). The end cap 118 may be coupled to the string 104 via any suitable type(s) of connection(s), such as a sewed connection, an adhesive connection, a fastener connection, other suitable type(s) of connection(s), or a combination thereof. The end cap 118 blocks the end of the string 104 from moving through the apertures. Accordingly, the string 104 couples the segments 80′ to one another while the string 104 is engaged with the segmented shaft 78′ (e.g., while the string extends through the apertures). Furthermore, the end cap 118 is configured to disengage the string 104 as the end of the bale wrap moves away from the segmented shaft 78′ to enable the segments 80′ to uncouple from one another. For example, as the end of the bale wrap moves away from the segmented shaft 78′, the string 104 may apply a force to the end cap 118 greater than the strength of the connection between the end cap 118 and the string 104. Accordingly, the string 104 may be pulled through the apertures, thereby enabling the segments 80′ to uncouple from one another.

In certain embodiments, the feed rollers or other suitable rollers of the baler are configured to receive the bale wrap from the bale wrap assembly. In addition, the rollers are configured to block movement of the end cap through the rollers. As a result, the end cap may move (e.g., under the influence of gravity) to the ramp. The ramp, in turn, may direct the end cap toward the field (e.g., via the shredder). The end cap may be formed from biodegradable material, thereby enabling the end cap to biodegrade on the field. Furthermore, in certain embodiments (e.g., in embodiments in which the segments of the segmented shaft are directed toward a storage compartment), the end cap may move to the storage compartment.

While the end cap 118 is positioned at an inner surface of the segmented shaft 78′ in the illustrated embodiment, in other embodiments, the end cap may be positioned at an outer surface of the segmented shaft. Furthermore, in certain embodiments, the end cap may be omitted. For example, the end of the string may be tied in a knot that resists being pulled through the apertures. However, as the end of the bale wrap moves away from the segmented shaft, the force applied to the string may be greater than the resistance provided by the knot. Accordingly, the string and the knot may be pulled through the apertures, thereby enabling the segments to uncouple from one another. In addition, while each segment 80′ includes three apertures in the illustrated embodiment, in other embodiments, at least one segment may include more or fewer apertures (e.g., 1, 2, 4, 5, 6, or more), and the string may extend through each aperture. In addition, while each aperture extends through the respective segment 80′ along the radial axis 114 in the illustrated embodiment, in other embodiments, at least one aperture may extend along another suitable direction. For example, in certain embodiments, the apertures may be oriented to enable the string to couple the segments to one another via a cross-stitch pattern. While the engagement feature 84′ includes a single string 104 in the illustrated embodiment, in other embodiments, the engagement feature may include multiple strings (e.g., each coupled to the bale wrap and extending through apertures of the segmented shaft). Furthermore, while one engagement feature 84′ including string(s) 104 is disclosed above, the bale wrap assembly 70′ may include multiple engagement features 84′, each including respective string(s) 104, distributed along the rotational axis 82/longitudinal axis 116 of the segmented shaft 78′.

In the illustrated embodiment, each segment 80′ includes a protrusion 120 and a recess 122. As illustrated, each protrusion 120 extends along the rotational axis 82/longitudinal axis 116, and each recess 122 extends along the rotational axis 82/longitudinal axis 116. Each protrusion 120 is configured to engage a respective recess 122 of an adjacent segment 80′, thereby facilitating coupling of the segments 80′ to one another. In the illustrated embodiment, the apertures and the string are positioned at the interface between a protrusion and a recess. However, in other embodiments, the apertures/string may be positioned at other suitable longitudinal location(s) of the segmented shaft (e.g., alone or in combination with the interface between the protrusion and the recess). Furthermore, the longitudinal extent of each protrusion/recess may be particularly configured to enhance the structural integrity of the segmented shaft while the respective engagement feature is engaged with the segmented shaft and to enable the segments to uncouple from one another as the engagement feature disengages the segmented shaft. While each segment of the segmented shaft includes a protrusion and a recess in the illustrated embodiment, in other embodiments, at least one segment may have another suitable configuration. For example, in certain embodiments, each segment may have a fluted longitudinal end configured to engage with a fluted longitudinal end of an adjacent segment. Furthermore, in certain embodiments, each segment may have a flat longitudinal end configured to engage a flat longitudinal end of an adjacent segment. In addition, in certain embodiments, the bale wrap assembly may include an adhesive configured to couple adjacent segments to one another. For example, the adhesive may be particularly configured to enhance the structural integrity of the segmented shaft while the engagement feature(s) are engaged with the segmented shaft and to enable the segments to uncouple from one another as the engagement feature(s) disengage the segmented shaft. Furthermore, in certain embodiments, the adhesive may be omitted.

FIG. 6 is a cross-sectional view of a portion of a further embodiment of a bale wrap assembly 70″ that may be employed within the agricultural system of FIG. 1. In the illustrated embodiment, at least one engagement feature 84″ (e.g., each engagement feature of the bale wrap assembly) includes a pin 124 (e.g., disruption element) and a string 104′ coupled to the pin 124. The string 104′ may be coupled to the pin 124 via any suitable type(s) of connection(s), such as a sewed connection, a fastener connection, an adhesive connection, other suitable type(s) of connection(s), or a combination thereof. The string 104′ is positioned at the end of the bale wrap (e.g., extending from the end of the bale wrap). For example, the string 104′ may be coupled to the bale wrap via a sewed connection, an adhesive connection, a fastener connection, other suitable type(s) of connection(s), or a combination thereof.

As illustrated, the pin 124 extends through an aperture of each segment 80″. In the illustrated embodiment, a first segment 106′ has an aperture 108′, and a second segment 110′ has an aperture 112′. Furthermore, in the illustrated embodiment, each aperture extends through the respective segment 80″ along the radial axis 114, and the aperture 108′ of the first segment 106′ is substantially aligned with the aperture 112′ of the second segment 110′ with respect to the longitudinal axis 116 (e.g., which is parallel to the rotational axis 82). The pin 124 extends through the aperture 108′ of the first segment 106′ and the aperture 112′ of the second segment 110′, thereby coupling the first segment 106′ and the second segment 110′ to one another.

The pin 124 couples the segments 80″ to one another while the pin 124 is engaged with the segmented shaft 78″ (e.g., while the pin extends through the apertures). Furthermore, friction between the pin 124 and the segments causes the pin 124 to resist being pulled out of the apertures. However, as the end of the bale wrap moves away from the segmented shaft 78″, the string 104′ may apply a force to the pin 124 greater than the friction force between the pin 124 and the segments. Accordingly, the pin 124 may be pulled through the apertures, thereby enabling the segments 80″ to uncouple from one another. Furthermore, the friction between the pin 124 (e.g., disruption element) and the segments may drive the segments to uncouple from one another as the end of the bale wrap moves away from the segmented shaft 78″.

In certain embodiments, the feed rollers or other suitable rollers of the baler are configured to receive the bale wrap from the bale wrap assembly. In addition, the rollers are configured to block movement of the pin through the rollers. As a result, the pin may disengage the string and move (e.g., under the influence of gravity) to the ramp. The ramp, in turn, may direct the pin toward the field (e.g., via the shredder). The pin may be formed from biodegradable material, thereby enabling the pin to biodegrade on the field. Furthermore, in certain embodiments (e.g., in embodiments in which the segments of the segmented shaft are directed toward a storage compartment), the pin may move to the storage compartment.

While each aperture extends through the respective segment 80″ along the radial axis 114 in the illustrated embodiment, in other embodiments, each aperture may extend along another suitable direction. Furthermore, while the engagement feature 84″ includes a single pin 124 in the illustrated embodiment, in other embodiments, the engagement feature may include multiple pins, each disposed within respective apertures of the segments. For example, in certain embodiments, a respective string may be coupled to each pin and to the bale wrap, or one string may be coupled to multiple pins and to the bale wrap. Furthermore, while the pin is coupled to the bale wrap via a string in the illustrated embodiment, in other embodiments, the pin may be coupled to the bale wrap via a strip of material or other suitable element. In addition, in certain embodiments, the pin may be directly coupled to the bale wrap (e.g., via a sewed connection, via an adhesive connection, via a fastener connection, via other suitable type(s) of connection(s), or a combination thereof). While one engagement feature 84″ including pin(s) 124 is disclosed above, the bale wrap assembly 70″ may include multiple engagement features 84″, each including respective pin(s) 124, distributed along the rotational axis 82/longitudinal axis 116 of the segmented shaft 78″.

In the illustrated embodiment, each segment 80″ includes a protrusion 120′ and a recess 122′. As illustrated, each protrusion 120′ extends along the rotational axis 82/longitudinal axis 116, and each recess 122′ extends along the rotational axis 82/longitudinal axis 116. Each protrusion 120′ is configured to engage a respective recess 122′ of an adjacent segment 80″, thereby facilitating coupling of the segments 80″ to one another. In the illustrated embodiment, the apertures and the pin are positioned at the interface between a protrusion and a recess. However, in other embodiments, the apertures/pin may be positioned at another suitable longitudinal location of the segmented shaft. Furthermore, the longitudinal extent of each protrusion/recess may be particularly configured to enhance the structural integrity of the segmented shaft while the respective engagement feature is engaged with the segmented shaft and to enable the segments to uncouple from one another as the engagement feature disengages the segmented shaft. While each segment of the segmented shaft includes a protrusion and a recess in the illustrated embodiment, in other embodiments, at least one segment may have another suitable configuration. For example, in certain embodiments, each segment may have a fluted longitudinal end configured to engage with a fluted longitudinal end of an adjacent segment. Furthermore, in certain embodiments, each segment may have a flat longitudinal end configured to engage a flat longitudinal end of an adjacent segment. In addition, in certain embodiments, the bale wrap assembly may include an adhesive configured to couple adjacent segments to one another. For example, the adhesive may be particularly configured to enhance the structural integrity of the segmented shaft while the engagement feature(s) are engaged with the segmented shaft and to enable the segments to uncouple from one another as the engagement feature(s) disengage the segmented shaft. Furthermore, in certain embodiments, the adhesive may be omitted.

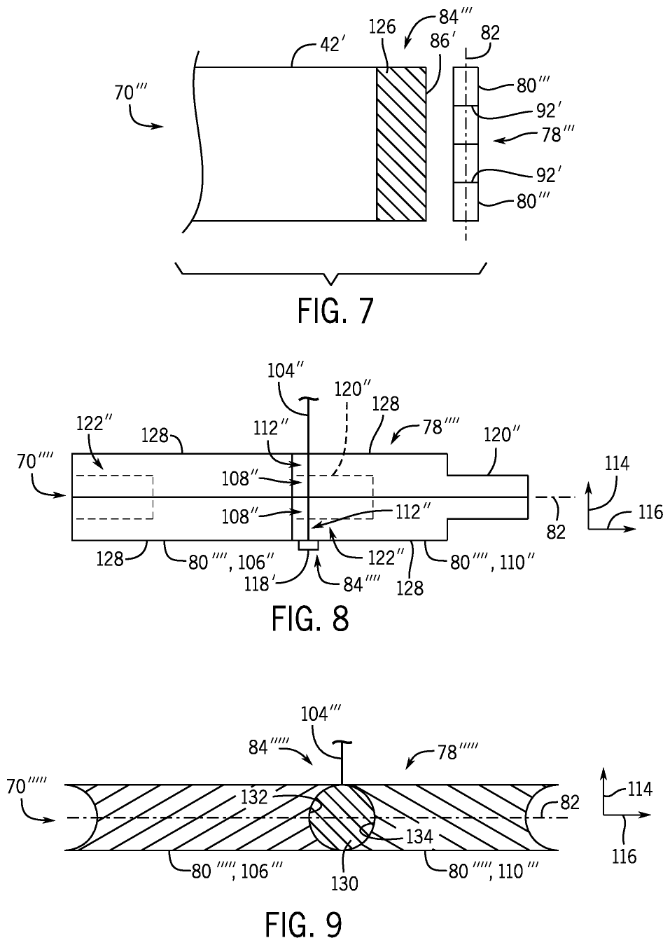

FIG. 7 is a top view of a portion of an embodiment of a bale wrap assembly 70″ that may be employed within the agricultural system of FIG. 1. In the illustrated embodiment, the bale wrap assembly 70′″ includes a single engagement feature 84′″, and the engagement feature 84″″ includes an adhesive 126 (e.g., adhesive layer) configured to couple the bale wrap 42′ to the segmented shaft 78′″. For example, the adhesive 126 may include an adhesive layer formed on the bale wrap 42′ (e.g., extending from the end 86′), an adhesive layer formed on the segmented shaft 78′″, or a combination thereof. The engagement feature 84′″ also includes a portion of the bale wrap 42′ extending from the end 86′ (e.g., the portion of the bale wrap 42′ coupled to the segmented shaft 78′″ by the adhesive 126 while the engagement feature 84′″ is engaged with the segmented shaft 78′″). With the bale wrap 42′ coupled to the segmented shaft 78′″ by the adhesive 126, the segments 80′″ of the segmented shaft 78′″ are coupled to one another, thereby forming the segmented shaft 78′″. However, as the bale wrap 42′ disengages the segmented shaft 78″, the segments 80′″ uncouple from one another. For example, the adhesive 126 may be particularly configured to enhance the structural integrity of the segmented shaft while the engagement feature is engaged with the segmented shaft and to enable the segments to uncouple from one another as the engagement feature disengages the segmented shaft (e.g., as the bale wrap disengages the segmented shaft).

The adhesive 126 may extend along any suitable portion of the longitudinal extent of the bale wrap 42′ (e.g., extent of the bale wrap along the direction of unrolling). For example, in certain embodiments, an adhesive layer formed on the bale wrap may extend a distance along the longitudinal extent of the bale wrap equal to the circumference of the segmented shaft. In other embodiments, an adhesive layer formed on the bale wrap may extend a distance along the longitudinal extent of the bale wrap greater than or less than the circumference of the segmented shaft. Furthermore, in certain embodiments, an adhesive layer formed on the segmented shaft may extend about the entire circumference of the segmented shaft. In other embodiments, an adhesive layer formed on the segmented shaft may extend about a portion of the circumference of the segmented shaft. In addition, in certain embodiments, the adhesive 126 may extend along the entire longitudinal extent of the segmented shaft 78′″ (e.g., the extent of the segmented shaft along the rotational axis/longitudinal axis)/width of the bale wrap 42′. In other embodiments, the adhesive may extend along a portion of the longitudinal extent of the segmented shaft/width of the bale wrap. For example, in certain embodiments, the adhesive may be formed as strips positioned at each segment interface 92′ of the segmented shaft 78′″.

FIG. 8 is a top view of a portion of another embodiment of a bale wrap assembly 70″″ that may be employed within the agricultural system of FIG. 1. In the illustrated embodiment, each segment 80″″ is formed from multiple circumferential sections 128. The circumferential sections 128 are configured to collectively form the segment 80″″, including a protrusion 120′ of the segment 80″″, which is configured to engage a respective recess 122′ of an adjacent segment 80″″ to couple the segments 80″″ to one another. In the illustrated embodiment, each segment 80″″ has two circumferential sections 128. However, in other embodiments, at least one segment may have more or fewer circumferential sections, such as 3, 4, 5, 6, or more. Furthermore, each circumferential section may have any suitable circumferential extent. For example, each circumferential section may have the same circumferential extent.

Furthermore, the engagement feature 84″″ includes a string 104′. The string 104″ is positioned at the end of the bale wrap (e.g., extending from the end of the bale wrap). For example, the string 104″ may be coupled to the bale wrap via a sewed connection, an adhesive connection, a fastener connection, other suitable type(s) of connection(s), or a combination thereof. As illustrated, the string 104″ extends through apertures of each segment 80″″. In the illustrated embodiment, a first segment 106″ has two apertures 108″, and a second segment 110″ has two apertures 112″. Furthermore, in the illustrated embodiment, each aperture extends through the respective segment 80″″ along the radial axis 114, and each aperture 108″ of the first segment 106″ is substantially aligned with a respective aperture 112″ of the second segment 110″ with respect to the longitudinal axis 116 (e.g., which is parallel to the rotational axis 82). The string 104″ extends through each aperture 108″ of the first segment 106″ and each aperture 112″ of the second segment 110″, thereby coupling the first segment 106″ and the second segment 110″ to one another.

As illustrated, an aperture is formed in each circumferential section 128. Accordingly, the string 104″ extends through an aperture 108″ of a first circumferential section 128 and an aperture 108″ of a second circumferential section of the first segment 106″ to couple the first circumferential section and the second circumferential section of the first segment to one another. In addition, the string 104″ extends through an aperture 112″ of a first circumferential section 128 and an aperture 112″ of a second circumferential section of the second segment 110″ to couple the first circumferential section and the second circumferential section of the second segment to one another. Accordingly, the string 104″ couples the circumferential sections of the first segment to one another, the circumferential sections of the second segment to one another, and the first segment and the second segment to one another.

In the illustrated embodiment, the engagement feature 84″″ includes an end cap 118′ coupled to the end of the string 104″ (e.g., the end opposite the end coupled to the bale wrap). The end cap 118′ may be coupled to the string 104″ via any suitable type(s) of connection(s), such as a sewed connection, an adhesive connection, a fastener connection, other suitable type(s) of connection(s), or a combination thereof. The end cap 118′ blocks the end of the string 104″ from moving through the apertures. Accordingly, the string 104 couples the circumferential sections 128 of the first segment 106″ to one another, the circumferential sections 128 of the second segment 110″ to one another, and the segments 80″″ to one another while the string 104″ is engaged with the segmented shaft 78″″ (e.g., while the string extends through the apertures). Furthermore, the end cap 118′ is configured to disengage the string 104″ as the end of the bale wrap moves away from the segmented shaft 78″″ to enable the segments 80″ to uncouple from one another, to enable the circumferential sections 128 of the first segment 106″ to uncouple from one another, and to enable the circumferential sections 128 of the second segment 110″ to uncouple from one another. For example, as the end of the bale wrap moves away from the segmented shaft 78″″, the string 104″ may apply a force to the end cap 118′ greater than the strength of the connection between the end cap 118′ and the string 104″. Accordingly, the string 104″ may be pulled through the apertures, thereby enabling the segments 80″″ to uncouple from one another and the circumferential sections to uncouple from one another.

In certain embodiments, the feed rollers or other suitable rollers of the baler are configured to receive the bale wrap from the bale wrap assembly. In addition, the rollers are configured to block movement of the end cap through the rollers. As a result, the end cap may move (e.g., under the influence of gravity) to the ramp. The ramp, in turn, may direct the end cap toward the field (e.g., via the shredder). The end cap may be formed from biodegradable material, thereby enabling the end cap to biodegrade on the field. Furthermore, in certain embodiments (e.g., in embodiments in which the segments of the segmented shaft are directed toward a storage compartment), the end cap may move to the storage compartment.

In certain embodiments, the end cap may be omitted. For example, the end of the string may be tied in a knot that resists being pulled through the apertures. However, as the end of the bale wrap moves away from the segmented shaft, the force applied to the string may be greater than the resistance provided by the knot. Accordingly, the string and the knot may be pulled through the apertures, thereby enabling the segments to uncouple from one another and the circumferential sections to uncouple from one another. In addition, while each segment 80″″ includes two apertures in the illustrated embodiment (e.g., one for each circumferential section), in other embodiments, each segment may include more apertures (e.g., 2, 4, 5, 6, or more for each circumferential section), and the string may extend through each aperture. In addition, while each aperture extends through the respective segment 80″″ along the radial axis 114 in the illustrated embodiment, in other embodiments, at least one aperture may extend along another suitable direction. For example, in certain embodiments, the apertures may be oriented to enable the string to couple the segments to one another and/or the circumferential sections to one another via a cross-stitch pattern. While the engagement feature 84″″ includes a single string 104 in the illustrated embodiment, in other embodiments, the engagement feature may include multiple strings (e.g., each coupled to the bale wrap and extending through apertures of the segmented shaft). Furthermore, while one engagement feature 84″″ including string(s) 104″ is disclosed above, the bale wrap assembly 70″″ may include multiple engagement features 84″″, each including respective string(s) 104″, distributed along the rotational axis 82/longitudinal axis 116 of the segmented shaft 78″″. While engagement feature(s) including string(s) are disclosed above with regard to FIG. 8, in certain embodiments, at least one engagement feature may include pin(s), such as the pin(s) disclosed above with reference to FIG. 6, configured to selectively couple the circumferential sections of at least one segment to one another and the at least one segment to another segment. Furthermore, in certain embodiments, at least one engagement feature may include a combination of string(s) and pin(s).

As previously discussed, each segment 80″″ includes a protrusion 120″ and a recess 122″. As illustrated, each protrusion 120″ extends along the rotational axis 82/longitudinal axis 116, and each recess 122″ extends along the rotational axis 82/longitudinal axis 116. Each protrusion 120″ is configured to engage a respective recess 122″ of an adjacent segment 80″″, thereby facilitating coupling of the segments 80″″ to one another. In the illustrated embodiment, the apertures and the string are positioned at the interface between a protrusion and a recess. However, in other embodiments, the apertures/string may be positioned at another suitable longitudinal location of the segmented shaft. Furthermore, the longitudinal extent of each protrusion/recess may be particularly configured to enhance the structural integrity of the segmented shaft while the respective engagement feature is engaged with the segmented shaft and to enable the segments to uncouple from one another as the engagement feature disengages the segmented shaft. While each segment of the segmented shaft includes a protrusion and a recess in the illustrated embodiment, in other embodiments, at least one segment may have another suitable configuration. For example, in certain embodiments, each segment may have a fluted longitudinal end configured to engage with a fluted longitudinal end of an adjacent segment. Furthermore, in certain embodiments, each segment may have a flat longitudinal end configured to engage a flat longitudinal end of an adjacent segment. In addition, in certain embodiments, the bale wrap assembly may include an adhesive configured to couple adjacent segments to one another. For example, the adhesive may be particularly configured to enhance the structural integrity of the segmented shaft while the engagement feature(s) are engaged with the segmented shaft and to enable the segments to uncouple from one another as the engagement feature(s) disengage the segmented shaft. Furthermore, in certain embodiments, the adhesive may be omitted.

In the illustrated embodiment, each segment of the segmented shaft includes multiple circumferential sections. However, in other embodiments, only a portion (e.g., 1, 2, 3, etc.) segments may include multiple circumferential sections, and the other segment(s) may be formed as a single element. In such embodiments, the string may couple a first segment formed from circumferential sections to a second segment formed as a single element by extending through at least one aperture in each circumferential section of the first segment and through at least one aperture in the second segment.

FIG. 9 is a cross-sectional view of a portion of a further embodiment of a bale wrap assembly 70′″″ that may be employed within the agricultural system of FIG. 1. In the illustrated embodiment, at least one engagement feature 84′″″ (e.g., each engagement feature of the bale wrap assembly) includes a plug 130 (e.g., disruption element) and a string 104″ coupled to the plug 130. The string 104′″ may be coupled to the plug 130 via any suitable type(s) of connection(s), such as a sewed connection, a fastener connection, an adhesive connection, other suitable type(s) of connection(s), or a combination thereof. The string 104′″ is positioned at the end of the bale wrap (e.g., extending from the end of the bale wrap). For example, the string 104′″ may be coupled to the bale wrap via a sewed connection, an adhesive connection, a fastener connection, other suitable type(s) of connection(s), or a combination thereof.

In the illustrated embodiment, the plug 130 is disposed within a recess 132 in a first segment 106′″ and within a recess 134 in a second segment 110′″. Furthermore, the plug 130 is coupled to the first segment 106′″ via an adhesive, and the plug 130 is coupled to the second segment 110′″ via an adhesive. Accordingly, the plug 130 couples the first segment 106′″ and the second segment 110′″ to one another while the plug 130 is engaged with the segmented shaft 78′″″. The adhesive may be particularly configured to enhance the structural integrity of the segmented shaft while the engagement feature is engaged with the segmented shaft and to enable the segments to uncouple from one another as the engagement feature disengages the segmented shaft. In the illustrated embodiment, the plug 130 has a spherical shape. However, in other embodiments, the plug may have a polygonal shape (e.g., cubical, etc.), a conical shape, a cylindrical shape, or another suitable shape. As the end of the bale wrap moves away from the segmented shaft 78′″″, the string 104′″ may apply a force to the plug 130 (e.g., disruption element) sufficient to cause the plug 130 to disengage the segmented shaft 78′″″ and to drive the segments to uncouple from one another (e.g., to over come the connective force applied by the adhesive). Accordingly, the plug 130 is configured to couple the segments to one another while engaged with the segmented shaft and to disengage the segmented shaft as the end of the bale wrap moves away from the segmented shaft to cause (e.g., enable) the segments to uncouple from one another.

In certain embodiments, the feed rollers or other suitable rollers of the baler are configured to receive the bale wrap from the bale wrap assembly. In addition, the rollers are configured to block movement of the plug through the rollers. As a result, the plug may disengage the string and move (e.g., under the influence of gravity) to the ramp. The ramp, in turn, may direct the plug toward the field (e.g., via the shredder). The plug may be formed from biodegradable material, thereby enabling the plug to biodegrade on the field. Furthermore, in certain embodiments (e.g., in embodiments in which the segments of the segmented shaft are directed toward a storage compartment), the plug may move to the storage compartment.

While the plug is coupled to the bale wrap via a string in the illustrated embodiment, in other embodiments, the plug may be coupled to the bale wrap via a strip of material or other suitable element. In addition, in certain embodiments, the plug may be directly coupled to the bale wrap (e.g., via a sewed connection, via an adhesive connection, via a fastener connection, via other suitable type(s) of connection(s), or a combination thereof). While one engagement feature 84′″″ including the plug 130 is disclosed above, the bale wrap assembly 70′″″ may include multiple engagement features 84′″″, each including a respective plug 130, distributed along the rotational axis 82/longitudinal axis 116 of the segmented shaft 78′″″.

Any of the segmented shaft interfaces (e.g., protrusion/recess, fluted, flat) disclosed herein may be used with any suitable engagement feature (e.g., string, pin) disclosed above. Furthermore, in certain embodiments, the segmented shaft may include decoupling feature(s) positioned at the interface(s) between segments to facilitate uncoupling of the segments in response to the engagement feature(s) disengaging the segmented shaft. For example, in certain embodiments, the segmented shaft may include a threaded connection at an interface between adjacent segments. In such embodiments, rotation of the segmented shaft after the engagement feature is disengaged may drive the segments to rotate relative to one another, thereby driving the segments to disengage. Furthermore, the segmented shaft may include an angled portion at the interface between adjacent segments. In such embodiments, disengagement of the engagement feature may drive one segment to move along the angled portion of the other segment, thereby driving the segments to disengage. In addition, while a segmented shaft formed from multiple individually formed segments is disclosed above, in certain embodiments, the segmented shaft may be formed as a single element with weakened (e.g., perforated) portion(s) between the segments. In such embodiments, disengagement of the engagement feature(s) from the segmented shaft may cause the segmented shaft to break at the weakened portion(s).

Furthermore, in certain embodiments, the shaft may not be segmented, and the baler may include a knife assembly configured to cut the shaft into segments after the bale wrap disengages the shaft. For example, the bale wrap shaft drive system may drive the shaft to rotate (e.g., continue to drive the shaft to rotate) after the bale wrap disengages the shaft. One or more blades of the knife assembly may then be driven into contact with the shaft (e.g., via actuator(s)). The blade(s) may cut the shaft into segments as the shaft rotates. Once the segments are cut, the segments may move under the influence of gravity to the ramp, which may direct the segments toward the field (e.g., via the shredder). As previously discussed, the shaft may be formed from a biodegradable material, thereby enabling the segments to biodegrade on the field.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A bale wrap assembly for an agricultural baler, comprising:
a segmented shaft comprising a plurality of segments configured to couple to one another along a rotational axis of the segmented shaft;
a bale wrap configured to be disposed about the segmented shaft; and
at least one engagement feature positioned at an end of the bale wrap and configured to engage the segmented shaft, wherein the at least one engagement feature is configured to couple the plurality of segments to one another while engaged with the segmented shaft, and the at least one engagement feature is configured to disengage the segmented shaft as the end of the bale wrap moves away from the segmented shaft to enable the plurality of segments to uncouple from one another.

2. The bale wrap assembly of claim 1, wherein the at least one engagement feature comprises:
a strip of material configured to be disposed about the segmented shaft; and
an adhesive configured to couple the strip of material to the segmented shaft at a respective interface between two segments of the plurality of segments.

3. The bale wrap assembly of claim 1, wherein the at least one engagement feature comprises a string configured to extend through an aperture in a first segment of the plurality of segments and an aperture in a second segment of the plurality of segments to couple the first segment and the second segment to one another.

4. The bale wrap assembly of claim 1, wherein the at least one engagement feature comprises a pin configured to extend through an aperture in a first segment of the plurality of segments and an aperture in a second segment of the plurality of segments to couple the first segment and the second segment to one another, and the pin is formed entirely from biodegradable material.

5. The bale wrap assembly of claim 1, wherein the at least one engagement feature comprises an adhesive configured to couple the bale wrap to the segmented shaft.

6. The bale wrap assembly of claim 1, wherein at least one segment of the plurality of segments is formed from a plurality of circumferential sections, the plurality of circumferential sections are configured to collectively form a protrusion configured to engage a recess of another segment of the plurality of segments to couple the at least one segment to the other segment, and the at least one engagement feature comprises a string configured to extend through an aperture of a first circumferential section of the plurality of circumferential sections and an aperture of a second circumferential section of the plurality of circumferential sections to couple the first circumferential section and the second circumferential section to one another and to couple the at least one segment to the other segment.

7. The bale wrap assembly of claim 1, wherein the segmented shaft is formed entirely from biodegradable material.

8. An agricultural baler, comprising:
a bale wrap assembly, comprising:
a segmented shaft comprising a plurality of segments configured to couple to one another along a rotational axis of the segmented shaft;
a bale wrap configured to be disposed about the segmented shaft; and
at least one engagement feature positioned at an end of the bale wrap and configured to engage the segmented shaft, wherein the at least one engagement feature is configured to couple the plurality of segments to one another while engaged with the segmented shaft, and the at least one engagement feature is configured to disengage the segmented shaft as the end of the bale wrap moves away from the segmented shaft to enable the plurality of segments to uncouple from one another.

9. The agricultural baler of claim 8, comprising a shredder configured to:
receive the plurality of segments in response to the plurality of segments being uncoupled from one another;
shred each segment of the plurality of segments to form segment material; and
direct the segment material to a field.

10. The agricultural baler of claim 8, comprising a ramp positioned below the segmented shaft, wherein the ramp is configured to receive the plurality of segments in response to the plurality of segments being uncoupled from one another, and the ramp is configured to direct the plurality of segments toward a field.

11. The agricultural baler of claim 8, comprising a plurality of rollers, wherein the plurality of rollers are configured to receive the bale wrap from the bale wrap assembly, and the plurality of rollers are configured to block movement of at least a portion of the at least one engagement feature through the plurality of rollers.

12. The agricultural baler of claim 8, wherein the segmented shaft is formed entirely from biodegradable material.

13. The agricultural baler of claim 8, wherein the at least one engagement feature comprises an adhesive configured to couple the bale wrap to the segmented shaft.

14. The agricultural baler of claim 8, wherein the at least one engagement feature comprises:
a strip of material configured to be disposed about the segmented shaft; and
an adhesive configured to couple the strip of material to the segmented shaft at a respective interface between two segments of the plurality of segments.

15. A bale wrap assembly for an agricultural baler, comprising:
a segmented shaft comprising a plurality of segments configured to couple to one another along a rotational axis of the segmented shaft;
a bale wrap configured to be disposed about the segmented shaft; and
at least one engagement feature comprising a disruption element configured to engage with adjacent segments of the plurality of segments, wherein the disruption element is coupled to the bale wrap, and the disruption element is configured to drive the adjacent segments to uncoupled from one another as the end of the bale wrap moves away from the segmented shaft.

16. The bale wrap assembly of claim 15, wherein the disruption element comprises a pin configured to extend through an aperture in a first segment of the adjacent segments and an aperture in a second segment of the adjacent segments, and the pin is formed entirely from biodegradable material.

17. The bale wrap assembly of claim 15, wherein the disruption element comprises a plug configured to be disposed within a recess in a first segment of the adjacent segments and within a recess in a second segment of the adjacent segments, and the plug is formed entirely from biodegradable material.

18. The bale wrap assembly of claim 15, comprising an adhesive configured to couple the adjacent segments to one another.

19. The bale wrap assembly of claim 15, wherein the at least one engagement feature comprises a string coupled to the bale wrap and to the disruption element.

20. The bale wrap assembly of claim 15, wherein the segmented shaft is formed entirely from biodegradable material.
